(19) United States
(12) Patent Application Publication
(10) Pub. No.: US 2004/0240166 A1
(43) Pub. Date: Dec. 2, 2004

(54) Computer face plate apparatus

(76) Inventor: Yi-Lung Kuo, Keelung (TW)

Correspondence Address: FENWICK & WEST LLP, SILICON VALLEY CENTER, 801 CALIFORNIA STREET, MOUNTAIN VIEW, CA, 94041, US

(21) Appl. No.: 10/767,225

(22) Filed: Jan. 28, 2004

(30) Foreign Application Priority Data
Jan. 28, 2003 (TW) 092201573

(51) Int. Cl. G06F 1/16

(52) U.S. Cl. 361/683; 361/724; 312/223.2

(57) ABSTRACT

A computer face plate apparatus shields computer drive and port interfaces from their environments, thereby reducing the flow of dusty air to electronic components stored within the computer. After the apparatus is affixed to the computer chassis, a cover plate can be closed or opened, enabling access to various drive interfaces. In addition, a separate second cover plate 6 remains closed when the port interfaces are not in use, and it can be opened to access the ports behind it. In an embodiment, frequently used CD/DVD drives can be accessed through a drive door without having to open the cover plate.

### CROSS REFERENCE TO RELATED APPLICATIONS

This application claims the right of priority based on Taiwanese application serial no. 092201573, filed Jan. 28, 2003, which is herein incorporated in its entirety by reference.

### BACKGROUND

1. Field of the Invention

This invention relates generally to computer chassis accessories, and specifically to front panel covers for computers.

2. Background of the Invention

The personalization of personal computers has been made possible by a substantial growth in computer system and configuration options. Confronted with a dizzying array of peripheral, operating system, gaming accessory, wireless, memory, CPU, audio card, video camera, speaker system, CD/DVD/VCDs player, and burner component options, ordinary consumers are increasingly undertaking a task once the exclusive domain of technophiles—building one's own computer.

It is now commonplace for computer chassis to contain at least three drive bays and numerous ports to accommodate various drives and plug-in components. As consumers pick and choose the different components that will go into their computers, computer chassis may contain unused slots or include slots or drives that are frequently idle, such as the floppy drive. In typical configurations, port and drive interfaces are left exposed or are covered by hinged windows that are pushed in when the drive behind the window is used. This can create a significant dust problem as air carrying dirt particles can seep into the chassis through the drive slots or windows. Dust can coat the circuits stored within a chassis, making them less efficient and shortening their useful life.

Furthermore, use of the drives and ports with external media such as CDs, DVDs, or USB or other components subjects the integrated circuits stored within the chassis to disturbances. The frequent movement of such external components can destabilize internal operations within the chassis. Therefore, it would be desirable to devise a structure to provide greater protection against the dust and disruption associated with the multiple drives and ports of a computer.

### SUMMARY OF THE INVENTION

Accordingly, a face plate apparatus shields drive and port interfaces of a computer. The apparatus may be attached to the front of a computer chassis. In an embodiment, the apparatus comprises several cover plates, which can be opened to allow access to the port and drive interfaces behind the panel segments and conceal drive and port interfaces behind them when in a closed position. In another embodiment, a drive door covers a CD-ROM interface to enable easy access to the CD-ROM drive while also limiting exposure of the drive to the outside environment. The apparatus thereby reduces the flow of dusty air to the electronic components stored within a computer.

In one embodiment the apparatus includes a cover plate for concealing a plurality of interfaces for drives of different sizes of a computer while in a closed position, a window for the cover plate, a drive door for covering the window in the cover plate through which a drive interface can be accessed while the cover plate is in a closed position, and a mechanism to secure the cover plate to a computer chassis.

In an embodiment, the computer chassis comprises a small form factor computer chassis. In another, there is a second cover plate for concealing a plurality of port interfaces of a computer while in a closed position. In another embodiment, the cover plate and drive door conceal two 5¼-inch drives and a 3½-inch drive while both are in a closed position.

### BRIEF DESCRIPTION OF THE DRAWINGS

FIG. 1 is an exploded view of a computer face plate apparatus and the front of a computer chassis in accordance with an embodiment of the invention.

FIG. 2 is a front view of a computer face plate apparatus with the cover plates closed in accordance with an embodiment of the invention.

FIG. 3 is a front view of a computer face plate apparatus with a cover plate open in accordance with an embodiment of the invention.

### DETAILED DESCRIPTION OF THE PREFERRED EMBODIMENTS

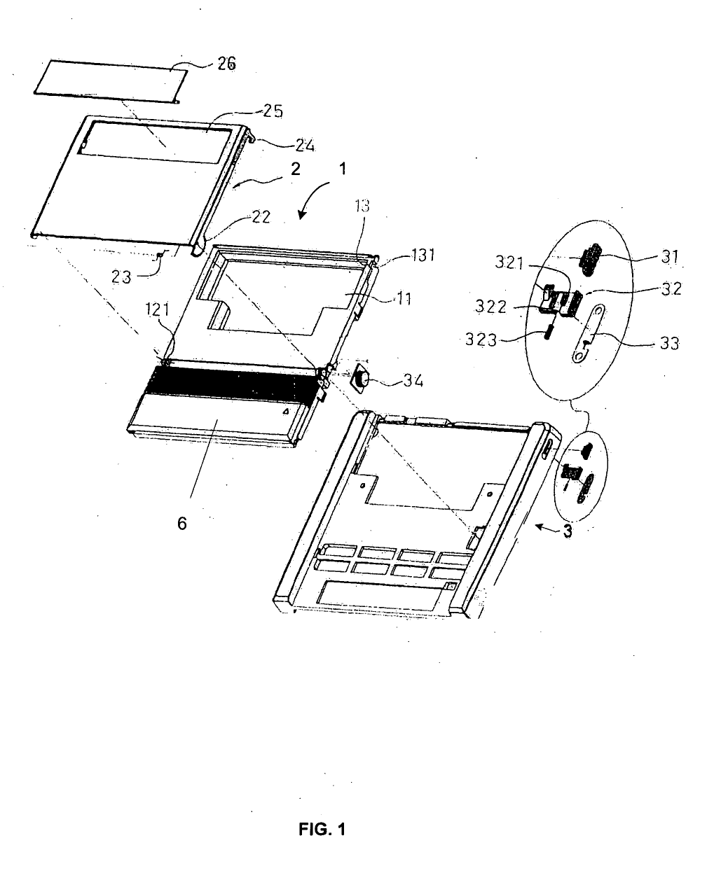

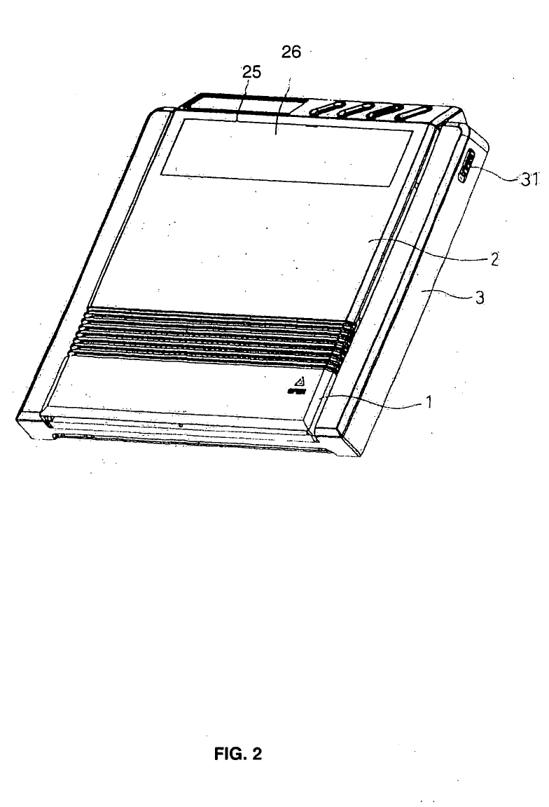

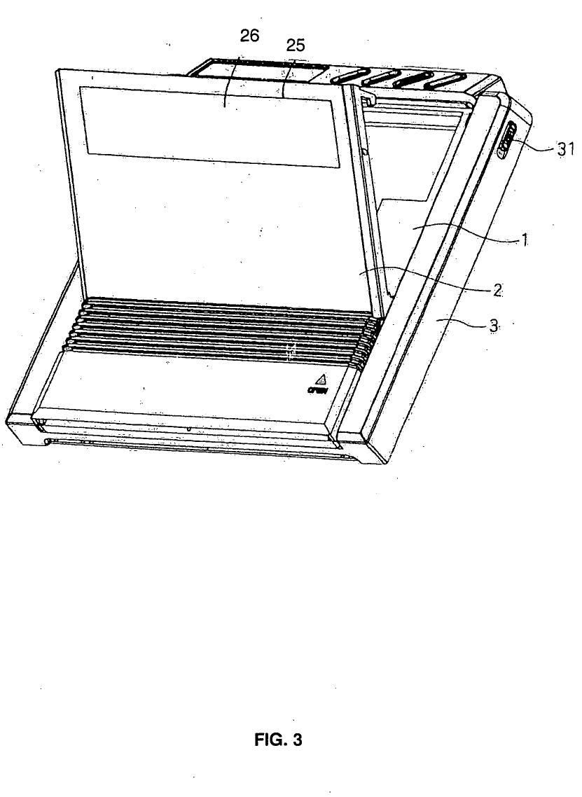

FIG. 1 is an exploded view of a computer face plate apparatus and the front of a computer chassis in accordance with an embodiment of the invention. The apparatus in FIG. 1 includes a cover plate 2 mounted on top of a slotted panel 1. The apparatus can be attached to the front outer panel 3 of a computer chassis. The cover plate 2 can be in an open position, as shown in FIG. 3, or in a closed position, as shown in FIG. 2. When open, the cover plate 2 allows drives, for instance floppy and DVD drives, installed in the computer to be accessed. When closed, the cover plate 2 conceals these drives, thereby decreasing the risk of unwanted particles seeping into the computer chassis. In addition, a second cover plate 6 that can be open or closed is mounted on the slotted panel 1. When the second cover plate 6 is open, the port interfaces in the bottom portion of a computer chassis can be accessed from outside the computer; however, the second cover plate 6 may also be closed, limiting exposure when the ports are not in use.

As shown in FIG. 1, a computer chassis is comprised in part of a front outer panel 3. Such a front outer panel 3 could be permanently attached to the main chassis structure (not shown), could be part of the main chassis structure, or could, as shown, be removable from the main chassis structure. Typically, the main computer chassis structure houses the power supply, cooling system, motherboard, processor, memory, and drive subsystems, as well as other hardware devices.

The front outer panel 3 of the chassis contains a window bordering the top of the panel through which various 3½-inch and 5¼-inch drives or other storage media can be accessed. The panel 3 also contains numerous small windows along the bottom of the front outer panel 3 through which ports can be accessed, for example to support VGA, USB, LAN, IEEE, wireless, keyboard, microphone, and other connections. However, various other combinations and configurations are also possible.

As shown in FIG. 1, a slotted panel 1 may be attached to the front outer panel 3 of a computer chassis. When installed over the front outer panel 3, the slotted panel 1 conceals port interfaces and limits air flow from outside the computer into the chassis. Two cover plates 2 and 6 are attached to the slotted panel 1. As shown, the second cover plate 6 comprises a small panel mounted to the slotted panel; alternatively, the second cover plate 6 can comprise a panel that is mounted directly to the front outer panel 3. The second cover plate 6 is configured to rotate around a pivot shaft 21. In a closed position, when the second cover plate 6 lies parallel to the front outer panel 3 of the chassis, the second cover plate 6 can cover port interfaces along the bottom of the chassis.

Mounted to the slotted panel 1 is a cover plate 2 that, as shown in FIG. 1, covers drive interfaces left exposed by the window 11 in the slotted panel 1. Rotating around a linear spring 23, the cover plate 2 may be in an open position (as shown in FIG. 3) or a closed position (as shown in FIG. 2). The cover plate 2 includes a panel slot 25 configured to allow access to a 5¼-inch drive or drives through a drive door 26. This particular configuration makes it possible to access the more commonly used 5¼-inch drives through the drive door 26, even when the cover plate 2 is in the closed position, as in FIG. 2. The less commonly used 3½-inch drive remains hidden behind the cover plate 2 in this position. The cover plate 2 may be composed of dark transparent or opaque material, to allow drives stored behind the cover plate 2 to be seen from outside the cover plate 2.

In the apparatus of FIG. 1, the cover plate 2 is secured to the outer front panel 3 of the computer chassis. This is achieved, in part, through an attachment mechanism comprising a slide key 31 is linked to a push pedal 32. The push pedal is attached to the outer front panel 3 of the computer chassis with a fixed plate 33 that includes a stopper 321 and a recess 322 in which a spring 323 is embedded. A hook 24 on the cover plate 2 secures the cover plate 2 to the outer front panel 3 of the chassis by clasping the stopper 321 through a hole 13 in the slotted panel. When the hook is released, the cover plate 2 rotates around a linear spring 23, thus opening the cover plate 2. A set of engaged gears 22 and 34 rotate in opposite directions, creating a slow open/close mechanism.

To take advantage of the invention, a user mounts the cover plate 2 and the slotted panel 1 of FIG. 1 onto the front panel 3 of a computer chassis. In an embodiment, the computer chassis holds two 5¼-inch drives mounted on top of one 3½-inch drive within the confines of the computer and also features several communication ports. The interfaces for these drives and ports are positioned on the front display of a computer.

When the computer drives and ports are not being used, the cover plate 2 and the second cover plate 6 can remain in a closed position, as shown in FIG. 2. In this closed position, dusty air is prevented from entering the chassis from the outside environment directly through the ports and drive interfaces. In addition, because the drive interfaces behind the cover plate 2 and the port interfaces behind the second cover plate 6 are hidden from view, it is more difficult for outsiders to discern what is within the chassis, increasing security by discouraging theft.

A user wanting to use the 5¼-inch drives can simply access a drive door 26 mounted inside the cover plate 2 and gain access to the 5¼-inch drive slots. Thus, the cover plate 2 does not need to be in an open position (as shown in FIG. 3) for CD-ROM or DVD drives to be accessed. However, in order to access the 3½-inch drive, a user will first open the cover plate 2. In the embodiment of FIG. 1, this is accomplished by unlatching a hook 24 on the cover plate 2 from an attachment mechanism comprising in part a slide key 31, hole 13, push pedal 32, and spring 323; however, other mechanisms may also be used.

When a user wants to access the ports hidden underneath the second cover plate 6, the second cover plate 6 can be opened so that it is perpendicular to the front outer panel 3 of the chassis. The second cover plate 6 may otherwise be kept closed when the ports stored beneath them are not in use. In an embodiment, even if a connector is installed in a port interface, the second cover plate 6 remains largely parallel to the front outer panel 3 of the chassis. In this way, the ports are only exposed when they are being accessed.

The foregoing description of embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

I claim:

1. A face plate apparatus for covering the drive and port interfaces of a computer, the apparatus comprising:
a cover plate for concealing a plurality of interfaces for drives of different sizes of a computer while in a closed position, the cover plate including a window;
a drive door for covering the window in the cover plate through which a drive interface can be accessed while the cover plate is in a closed position; and
a mechanism for securing the cover plate to a computer chassis.

2. The apparatus of claim 1, wherein the computer chassis comprises a small form factor computer chassis.

3. The apparatus of claim 1, further comprising a set of engaged gears to slow the open/close mechanism of the cover plate.

4. The apparatus of claim 1, wherein one of the slotted panel, cover plate, and drive door are substantially opaque.

5. The apparatus of claim 1, wherein the plurality of interfaces comprise an interface for a 3½-inch drive and an interface for a 5¼-inch drive.

6. The apparatus of claim 5, wherein the drive door, while in a closed position, is configured to conceal an interface for a 5¼-inch drive.

7. The apparatus of claim 1, further comprising:
a second cover plate for concealing a plurality of port interfaces of a computer while in a closed position.

8. The apparatus of claim 1, wherein the cover plate is secured to a computer chassis and is further configured to rotate around an axis parallel to the front of the computer chassis.

9. The panel of claim 6, wherein the computer chassis comprises a small form factor computer chassis, further comprising:
a second cover plate for concealing a plurality of interfaces for ports of a computer while in a closed position.
